(19) United States
(12) Patent Application Publication
(10) Pub. No.: US 2025/0153294 A1
(43) Pub. Date: May 15, 2025

(54) MACHINE TOOL

(71) Applicant: Schwäbische Werkzeugmaschinen GmbH, Schramberg-Waldmössingen (DE)

(72) Inventors: Christian STEMPFER, Geigenberg (AT); Stefan WEBER, Bösingen (DE)

(21) Appl. No.: 18/945,023

(22) Filed: Nov. 12, 2024

(30) Foreign Application Priority Data
Nov. 14, 2023 (EP) 23209906.9

(51) Int. Cl. B23Q 5/04

(52) U.S. Cl. CPC B23Q 5/04

(57) ABSTRACT

A machine tool having a machine frame, a first work spindle, a second work spindle, a first pivot carrier which is assigned to the first work spindle and which is mounted in the machine frame so as to be pivotable around a first pivot carrier axis, and which includes a first workpiece table and a second workpiece table, and at least one second pivot carrier associated with the second work spindle, which is swivel mounted in the machine frame around a second pivot carrier axis extending parallel to the first pivot carrier axis and spaced from the first pivot carrier axis, and which includes at least one first workpiece table and at least one second workpiece table. The first pivot carrier and/or the second pivot carrier can each be moved from a first pivot position into a second pivot position.

### CROSS-REFERENCE

This application claims the benefit of European application EP23209906.9 filed Nov. 14, 2023, which is incorporated herein by reference.

The invention is a machine tool.

Machine tools are known from the state of the art in various embodiments and designs. For example, these can include machine frames upon which a workpiece table is arranged, where workpieces can be detachably fastened. The workpieces can be processed by a work spindle on the machine tool.

In known machine tools, the workpiece table is loaded with workpieces while the work spindle is out of operation. In addition, the work spindle is at rest if the workpieces are removed from the workpiece table after processing. This can lead to long downtimes for the machine tool.

There are also other known machine tools, in which a so-called pivot carrier is swivel mounted on the machine frame, on which two workpiece tables are arranged that are positioned on opposite sides of the pivot carrier with regard to the pivot carrier axis of the pivot carrier. By rotating the pivot carrier around the pivot carrier axis, one workpiece table is moved from a work area to a loading area and at the same time the workplace table in the loading area is moved to the work area. This can reduce downtimes.

Other pivot carriers are known where two workpiece tables are arranged on each side of the pivot carrier, whereby each workpiece table is allocated its own work spindle. This must ensure a distance to the work spindles that allows the pivot carriers to be swivelled without collisions, where the distance from the pivot carrier axis to the work spindle is very great and the machine tool requires a lot of space.

### SUMMARY

One task of an embodiment of the invention is to propose a machine tool in which the distance between the pivot carrier axis and the work spindle is reduced, in particular while retaining or improving processing times.

This task is solved by a machine tool with a machine frame, with at least one first work spindle, with at least one second work spindle, with at least one first pivot carrier allocated to the first work spindle, which is mounted in the machine frame to swivel around a first pivot carrier axis and that includes at least one first workplace table and at least one second workpiece table, which is arranged with regard to the first pivot carrier axis on opposite sides on the first pivot carrier, and with at least one second pivot carrier allocated to the second work spindle, swivel mounted in the machine frame around a second pivot carrier axis extending parallel to the first pivot carrier axis and at a distance from the first pivot carrier axis, and including at least a first workpiece table and at least one second workpiece table, positioned on opposite sides of the second pivot carrier with respect to the second pivot carrier axis, whereby the first pivot carrier and/or the second pivot carrier can each be moved from a first pivot position, in which the respective first workpiece table is positioned in a work area and the first or rather the second work spindle is accessible, into a second pivot position, in which the respective second workpiece table is arranged in the work area and the first or rather the second work spindle is accessible.

As the machine tool includes a first pivot carrier and a second pivot carrier, each including a first workpiece table and a second workpiece table, the distances of the work spindles to the pivot axes can be kept short. The swivelling of two pivot carriers, with a workpiece table on each side, each uses a smaller rotation circle than one large pivot carrier with two workpiece tables on each side.

The machine tool can process a large number of workpieces because the first workpiece tables can be accessed by the first work spindle and the second work spindle in the first pivot position, and the second workpiece tables can be accessed in the second pivot position and the workpieces arranged therein can be processed.

The movement from the first pivot position into the second pivot position can involve a rotation through 180° around the first pivot axis or rather the second pivot axis.

The phrase “or rather” is taken to mean “and in the alternative case” and continues the relation in the previous sentence or partial sentence.

At least one first workpiece table and at least one second workpiece table can be arranged on the first pivot carrier in each case. These are opposite one another with regard to the first pivot carrier axis.

In addition, embodiments of the machine tool are conceivable in which the first pivot carrier includes two first workpiece tables that are both arranged in the work area in the first pivot position and includes at least two second workpiece tables arranged on the side opposite the first workpiece tables.

The same applies for the second pivot carrier. This can also include two first workpiece tables, both positioned in the work area, and two second workpiece tables positioned on the second pivot carrier on the side opposite the first workpiece tables with regard to the second pivot carrier axis.

Further embodiments are conceivable in which at least three first workpiece tables and at least three second workpiece tables are arranged on the first pivot carrier and/or on the second pivot carrier.

It proves to be advantageous if, in the first pivot position of the first pivot carrier and/or in the first pivot position of the second pivot carrier, the respective second workpiece table is arranged in a loading area, and/or if, in the second pivot position of the first pivot carrier and/or in the second pivot position of the second pivot carrier, the respective first workpiece table is arranged in the loading area.

If in the first pivot position of the first pivot carrier and/or in the first pivot position of the second pivot carrier the respective second workpiece table is arranged in the loading area, the second workpiece table can be loaded with workpieces or, if they were previously processed in the work area by the work spindles, removed from the workpiece table. The same applies correspondingly for the first workpiece tables.

In order to simplify the processing of workpieces, it proves to be advantageous if the at least one first workpiece table and/or the at least one second workpiece table on the first pivot carrier and/or if the at least one first workpiece table and/or the at least one second workpiece table on the second pivot carrier respectively is/are designed to pick up and hold at least one workpiece.

For this the first workpiece tables and the second workpiece table can include receptacles on which a workpiece or several workpieces can be detachably secured to one workpiece table in each case. Detachably secured can be understood to mean a force-fit and/or form-fit connection.

Embodiments of the machine tool are conceivable in which the first pivot carrier and the second pivot carrier can be decoupled with respect to their kinematics in an independent operating mode and can be moved separately and independently of one another into the first pivot position and into the second pivot position and/or in which the first pivot carrier and the second pivot carrier are coupled in a dependent operating mode with respect to their kinematics and can be moved together and simultaneously to the first pivot position and the second pivot position.

If the first pivot carrier and the second pivot carrier can be decoupled with respect to their kinematics in an independent operating mode and can be moved separately and independently of one another into the first pivot position and into the second pivot position, then a workpiece table that is already loaded with workpieces can be moved into the work area while the workpiece table positioned on the other pivot carrier is still being loaded. This can make the processing of workpieces more flexible. In this case, the first pivot carrier axis and the second pivot carrier axis can each be moved from the first pivot position to the second pivot position and back by their own drive.

The machine tool can build easily if the first pivot carrier and the second pivot carrier are coupled in a dependent operating mode with respect to their kinematics and can be moved together and simultaneously to the first pivot position and the second pivot position. In particular, the first pivot carrier and the second pivot carrier can be allocated a joint drive in order to turn around the first pivot carrier axis or rather the second pivot carrier axis. This allows the machine tool to be designed with a reduced number of parts or rather components.

The first pivot carrier and/or the second pivot carrier can be arranged anywhere on the machine frame. In the case of embodiments of the machine tools, the intention is that the first pivot carrier axis and the second pivot carrier axis, which runs parallel to the first pivot carrier axis, run parallel to a horizontal x axis, whereby the first pivot carrier axis and the second pivot carrier axis are at a distance to one another with regard to a vertical y axis, in particular arranged above one another with regard to the vertical y axis, or that the first pivot carrier axis and the second pivot carrier axis that runs parallel to the first pivot carrier axis run parallel to a vertical y axis, whereby the first pivot carrier axis and the second pivot carrier axis are at a distance to one another with regard to a horizontal x axis, in particular that they are arranged next to one another with regard to the horizontal x axis.

If the first pivot carrier axis and the second pivot carrier axis that runs parallel to the first pivot carrier axis run parallel to a horizontal x axis and they are at a distance to one another with regard to the vertical y axis, then the first pivot carrier and the second pivot carrier will be moved around the horizontal from the first pivot position into the second pivot position and back. If the first pivot carrier axis and the second pivot carrier axis that runs parallel to the first pivot carrier axis run parallel to a vertical y axis, then the first pivot carrier and the second pivot carrier will be moved around the vertical from the first pivot position into the second pivot position and back.

Moving is to be understood as rotating around the respective pivot carrier axis or swivelling around the respective pivot carrier axis.

Because of the different movement possibilities, caused by the course of the first pivot carrier axis and the second pivot carrier axis that runs parallel to the first pivot carrier axis, the machine tool can be optimised and adapted to different needs and spatial conditions, particularly to the available installation space.

It proves to be advantageous if the at least one first work spindle is mounted to rotate around a first spindle axis and/or if the at least one second work spindle is mounted around a second spindle axis, in particular whereby the first spindle axis and/or the second spindle axis runs/run parallel to a horizontal z axis that runs transverse to the vertical y axis and transverse to the horizontal x axis and/or in particular whereby the first spindle axis and the second spindle axis run parallel to one another.

If the first spindle axis and the second spindle axis run parallel to one another, workpieces on the first pivot carrier and workpieces on the second pivot carrier can be processed and a collision of the work spindles is prevented.

Furthermore, embodiments of the machine tool are conceivable in which the first work spindle and the second work spindle can be decoupled with respect to their kinematics and can be operated and/or moved separately and independently of one another and/or in which the first work spindle and the second work spindle are coupled with respect to their kinematics and can be operated and/or moved together and simultaneously.

If the first work spindle and the second work spindle can be decoupled with respect to their kinematics and can be operated and/or moved separately and independently of one another, then a workpiece table can be processed at the first pivot carrier or a workpiece table can be processed at the second pivot carrier, while the respective other pivot carrier is still undergoing a loading or unloading process. Furthermore, this enables the processing of workpieces with different target contours.

If the first work spindle and the second work spindle are coupled with respect to their kinematics and can be operated and/or moved together and simultaneously, then the machine tool can be designed in a simplified manner. This type of design is particularly advantageous if the workpieces to be processed are to have an identical target contour.

Furthermore, it proves to be advantageous if the first work spindle and the second work spindle are arranged vertically above one another, if the first pivot carrier axis and the second pivot carrier axis that runs parallel to the first pivot carrier axis run parallel to a horizontal x axis, and if the first work spindle and the second work spindle are arranged horizontally next to one another, if the first pivot carrier axis and the second pivot carrier axis that runs parallel to the first pivot carrier axis run parallel to a vertical y axis.

In principle it is conceivable that the first workpiece tables and/or the second workpiece tables are arranged on the respective pivot carrier so that they cannot rotate. The processing of workpieces can be improved if the respective first workpiece table is swivel mounted around a first workpiece table axis, which runs parallel or transversely to the allocated first pivot carrier axis of the first pivot carrier or rather the second pivot carrier axis of the second pivot carrier and/or if the respective second workpiece table runs around a second workpiece table axis that runs parallel or transversely to the allocated first pivot carrier axis of the first pivot carrier or rather the second pivot carrier axis of the second pivot carrier.

The first workpiece table axes of the first workpiece tables can run parallel or transversely to the allocated pivot carrier axis. In this case, embodiments are conceivable in which the first pivot carrier axis runs vertically and the first workpiece table axis and/or the second workpiece table axis runs/run transversely to this. Furthermore, in further embodiments both the first workpiece table axes and the allocated pivot carrier axes can run parallel to one another. The same applies to the second workpiece table axes.

Embodiments of the machine tool are preferred in which the first pivot carrier axis, the second pivot carrier axis and the first workpiece table axes and the second workpiece table axes run parallel to one another and parallel to the horizontal x axis, whereby the first pivot carrier axis and the second pivot carrier axis, whereby the first workpiece table axes are aligned with one another and/or the second workpiece table axes are aligned with one another or offset with respect to one another with respect to the vertical y axis extending transversely to it, or in that the first pivot carrier axis, the second pivot carrier axis and the first workpiece table axes and the second workpiece table axes extend parallel to one another and parallel to the vertically extending y axis, wherein the first pivot carrier axis and the second pivot carrier axis, wherein the first workpiece table axes are arranged in alignment with one another and/or wherein the second workpiece table axes are arranged offset from one another with respect to the horizontal x axis extending transversely to it.

In the machine tool embodiments described above, all axes of the workpiece tables and the pivot carriers run parallel to one another.

The first spindle axis of the first work spindle and/or the second spindle axis of the second work spindle can run transversely to this in both spatial orientations of the pivot carrier axes and the associated workpiece table axes.

The machine tool can be designed to be compact in terms of its spatial dimensions if, in the first pivot position and in the second pivot position, the first workpiece table and the second workpiece table of a pivot carrier are each arranged point-symmetrically to one another with respect to the associated pivot carrier axis of the respective pivot carrier on which they are arranged and, if the respective pivot carrier axis runs horizontally, the first workpiece table and the second workpiece table are arranged offset to one another with respect to a vertical axis and, in particular, the pivoting ranges of the first workpiece table and the second workpiece table of the associated pivot carrier overlap with a vertical plane running through the pivot carrier axis, and if the respective pivot carrier axis runs vertically, the first workpiece table and the second workpiece table are arranged offset relative to one another with respect to a horizontal axis and, in particular, the pivoting ranges of the first workpiece table and the second workpiece table of the associated pivot carrier overlap with a horizontal plane running through the pivot carrier axis.

This creates a so-called interlocked arrangement of the workpiece tables on the pivot carrier, whereby the machine tool can be designed in a more space-saving manner.

This interlocked arrangement can be achieved, for example, if, in the first pivot position, the distance between the first workpiece tables and the pivot axis is less than maximally possible.

The pivoting areas of the first workpiece tables and the pivoting areas of the second workpiece tables allocated to the respective first workpiece tables can overlap.

In this kind of embodiment, the respective workpiece table axes can be arranged offset to one another with regard to a transverse axis. If the respective workpiece table axes run, for example, parallel to a horizontal x axis, the first workpiece table axis is offset to the second workpiece table axis with regard to a vertical y axis.

In embodiments in which the first workpiece table axis and the second workpiece table axis are arranged parallel to a vertical y axis, these can be arranged offset to one another with respect to the horizontal x axis running transversely to them when they overlap on the pivot carrier.

Furthermore, it proves to be advantageous if on the first pivot carrier the distance between the first pivot carrier axis and the first workpiece table axis is less than the circumferential radius of the first workpiece table and/or the distance between the first pivot carrier axis and the second workpiece table axis is less than the circumferential radius of the second workpiece table, and/or if on the second pivot carrier the distance between the second pivot carrier axis and the first workpiece table axis is less than the circumferential radius of the first workpiece table and/or the distance between the second pivot carrier axis and the second workpiece table axis is less than the circumferential radius of the second workpiece table.

This also enables the machine tool to be designed with reduced installation space.

In order to enable loading and/or unloading of one workpiece table while simultaneously processing the opposite workpiece table, it proves to be advantageous if the first pivot carrier comprises a first partition wall by which the first workpiece table and the second workpiece table are spatially separated from each other in the first pivot position and in the second pivot position and the loading area is shielded from the working area in full or at least in sections and/or if the second pivot carrier includes a second partition wall by means of which the first workpiece table and the second workpiece table are spatially separated from one another in the first pivot position and in the second pivot position and the loading area is shielded from the working area in full or at least in sections.

In this case a machine tool operator is screened when accessing the loading area from the working area by the first partition wall and/or by the second partition wall.

The working area can extend across both the first pivot carrier and the second pivot carrier. Furthermore, embodiments of the machine tool are conceivable in which the first pivot carrier includes a first working area and the second pivot carrier includes a second working area, spatially separated from one another.

Furthermore, in this case the first pivot carrier can include a first loading area and the second pivot carrier can include a second loading area, spatially separated from one another.

The machine tool can be realised in a simplified manner if a joint working area and a joint loading area are allocated to the first pivot carrier and the second pivot carrier.

In particular, if the first workpiece table and the second workpiece table overlap each other at least in sections, a provision can be made in one embodiment of the machine tool that the first partition wall of the first pivot carrier can be flexibly and/or elastically bent around an axis running parallel to the first pivot carrier axis and/or that the second partition wall of the second pivot carrier can be flexibly and/or elastically bent around an axis running parallel to the second pivot carrier axis.

This allows the separation of the working area from the loading area to be adapted more easily.

In principle it is conceivable that the first pivot carrier is arranged directly adjacent to the second pivot carrier without gaps and/or joints. This enables the machine tool to be designed in a reduced space with regard to its dimensions.

In one embodiment of the machine tool, the intention is that the machine frame includes at least one separating section, which is arranged between the first pivot carrier and the second pivot carrier, wherein the first partition wall of the first pivot carrier, the separating section of the machine frame and the second partition wall of the second pivot carrier spatially separate the working area from the loading area in the first pivot position and in the second pivot position in full or at least in sections without gaps and/or joints.

Further features, details and advantages of the invention are apparent from the appended patent claims, from the drawing and from the following description of a preferred embodiment of the machine tool.

### BRIEF DESCRIPTION OF THE DRAWINGS

The drawing shows:

FIG. 1 A partially sectional side view of an embodiment of the machine tool.

### DETAILED DESCRIPTION

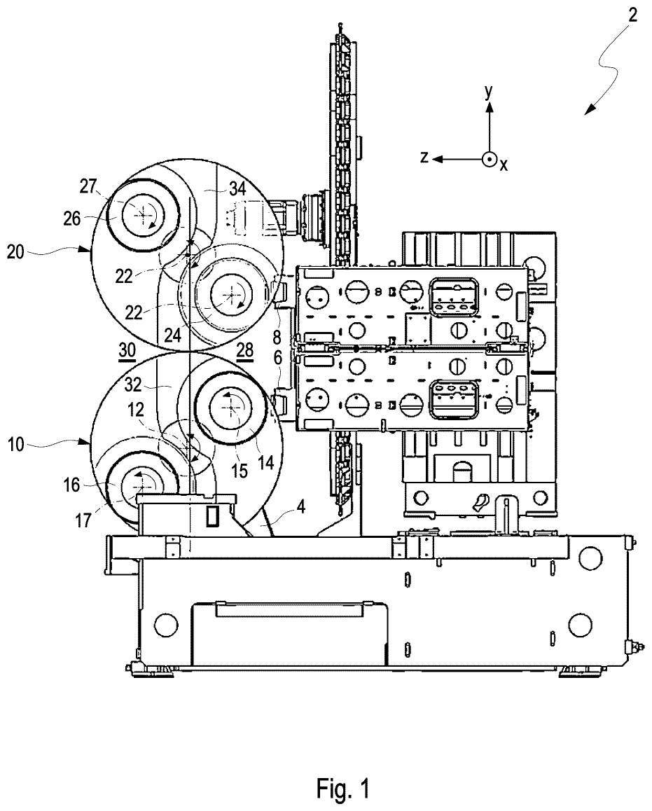

The FIGURE shows a machine tool labelled as a whole with the reference symbol 2. The machine tool 2 includes a machine frame 4. Furthermore, the machine tool 2 includes a first work spindle 6 and a second work spindle 8. In the embodiment shown in FIG. 1, the first work spindle 6 and the second work spindle 8 are arranged above one another with regard to a vertical y axis.

A first pivot carrier 10, to which the first work spindle 6 is allocated, is arranged on the machine frame 4. The first pivot carrier 10 is swivel mounted in the machine frame 4 around a first pivot carrier axis 12. A first workpiece table 14 and a second workpiece table 16 are arranged on the first pivot carrier 10. The first workpiece table 14 and the second workpiece table 16 are arranged on the first pivot carrier 10 opposite one another with regard to pivot carrier axis 12.

In addition, FIG. 1 shows an embodiment example of the machine tool 2, in which a second pivot carrier 20 is arranged on the machine frame 4, which is swivel mounted around a second pivot carrier axis 22 running parallel to the first pivot carrier axis 12. A first workpiece table 24 and a second workpiece table 26 are arranged on the first pivot carrier 20. The first workpiece table 24 and the second workpiece table 26 are arranged on the second pivot carrier 20 opposite one another with regard to second pivot carrier axis 22.

The first pivot carrier 10 and the second pivot carrier 20 can each be moved from a first pivot position, in which the respective first workpiece tables 14, 24 are arranged in a working area 28, to a second pivot position, in which the respective second workpiece tables 16, 26 are arranged in the working area 28.

If the first workpiece tables 14, 24 are arranged in the working area 28, the second workpiece tables 16, 26 are arranged in a loading area 30 in the embodiment example shown in FIG. 1.

At the first workpiece tables 14, 24 and second workpiece tables 16, 26, workpieces can be fixed for processing by the first work spindle 6 and/or the second work spindle 8.

In the embodiment example shown in FIG. 1, the first workpiece tables 14, 24 are mounted on the respective pivot carrier 10, 20 so as to be pivotable around a first workpiece axis 15, 25. The second workpiece tables 16, 26, are each swivel mounted on second workpiece table axes 17, 27.

FIG. 1 shows an embodiment example of the workpiece machine 2, in which the first pivot carrier axis 12, the second pivot carrier axis 22, the first workpiece axes 15, 25 and the second workpiece table axes 17, 27 run parallel to a horizontal x axis.

Furthermore, the first workpiece axis 15 is offset in relation to the second workpiece axis 17 with respect to a y axis running parallel to the vertical axis. The same applies to the first workpiece table axis 25 with regard to the second workpiece table axis 27.

In the embodiment example shown in FIG. 1, the first pivot carrier 10 and the second pivot carrier 20 are arranged on the machine frame 4 in such a way that their first pivot carrier axis 12 and their second pivot carrier axis 22 are arranged above one another with respect to a vertical y axis and both are aligned with one another. The first pivot carrier 10 and the second pivot carrier 20 continue from one another in relation to the vertical y axis.

Furthermore, FIG. 1 shows an interlocked arrangement of the workpiece tables 14, 24 on the respective pivot carriers 10, 20, whereby a distance between the work spindles 6, 8 and the respective pivot carrier axes 12, 22 is reduced.

In this case, in the first pivot position, the first workpiece table 14, 24 and the second workpiece table 16, 26 of a pivot carrier 10, 20 are each arranged point-symmetrically to one another with respect to the associated pivot carrier axis 12, 22 of the respective pivot carrier 10, 20 on which they are positioned, and with the horizontal run of the respective pivot carrier axis 12, 22 shown, the swivelling areas of the first workpiece table 14, 24 and the second workpiece table 16, 26 of the associated pivot carrier 10, 20 are not maximally spaced apart with respect to a vertical plane extending through the pivot carrier axis 12, 22, but are moved towards each other with respect to the maximum distance and the first workpiece table 14, 24 and the second workpiece table 16, 26 are arranged offset with respect to one another with respect to the vertical axis.

In order to separate the first workpiece table 14 from the second workpiece table 16, in particular in order to separate the working area 28 from the loading area 30, the first pivot carrier 10 includes a first partition wall 32, by means of which the first workpiece table 14 is spatially separated from the second workpiece table 16. Accordingly, the second pivot carrier 20 comprises a second partition wall 34, by means of which the first workpiece table 24 is spatially separated from the second workpiece table 26.

The features of the invention disclosed in the above description, in the claims as well as in the drawing, both individually and in any combination, may be essential in the realisation of the invention in its various embodiments within the scope of protection of the following claims.

### REFERENCE SYMBOL LIST

2 Machine tool
4 Machine frame
6 First work spindle
8 Second work spindle
10 First pivot carrier
12 First pivot carrier axis
14 First workpiece table
15 First workpiece table axis
16 Second workpiece table
17 Second workpiece table axis
20 Second pivot carrier
22 Second pivot carrier axis
24 First workpiece table
25 First workpiece table axis
26 Second workpiece table
27 Second workpiece table axis
28 Working area
30 Loading area
32 First partition wall
34 Second partition wall

1. A machine tool comprising a machine frame,
at least one first work spindle,
at least one second work spindle,
at least one first pivot carrier allocated to the first work spindle, which is mounted in the machine frame to swivel around a first pivot carrier axis and that includes at least one first workplace table and at least one second workpiece table, which is positioned with regard to the first pivot carrier axis on opposite sides on the first pivot carrier, and at least one second pivot carrier allocated to the second work spindle, swivel mounted in the machine frame around a second pivot carrier axis extending parallel to the first pivot carrier axis and at a distance from the first pivot carrier axis, and
at least a first workpiece table and at least one second workpiece table, arranged on opposite sides of the second pivot carrier with respect to the second pivot carrier axis,
wherein the first pivot carrier and/or the second pivot carrier can each be moved from a first pivot position, in which the respective first workpiece table is arranged in a working area and the first or rather the second work spindle is accessible, into a second pivot position, in which the respective second workpiece table is arranged in the working area and the first or rather the second work spindle is accessible.

2. The machine tool according to claim 1, wherein the first pivot position of the first pivot carrier and/or in the first pivot position of the second pivot carrier, the respective second workpiece table is arranged in a loading area, and/or if, in the second pivot position of the first pivot carrier and/or in the second pivot position of the second pivot carrier, the respective first workpiece table is arranged in the loading area.

3. The machine tool according to claim 1, wherein the at least one first workpiece table and/or the at least one second workpiece table on the first pivot carrier and/or the at least one first workpiece table and/or the at least one second workpiece table on the second pivot carrier respectively is/are designed to pick up and hold at least one workpiece.

4. The machine tool according to claim 1, wherein the first pivot carrier and the second pivot carrier can be decoupled with respect to their kinematics in an independent operating mode and can be moved separately and independently of one another into the first pivot position and into the second pivot position and/or in which the first pivot carrier and the second pivot carrier are coupled in a dependent operating mode with respect to their kinematics and can be moved together and simultaneously to the first pivot position and the second pivot position.

5. The machine tool according to claim 1, wherein the first pivot carrier axis and the second pivot carrier axis, which runs parallel to the first pivot carrier axis, run parallel to a horizontal x axis, whereby the first pivot carrier axis and the second pivot carrier axis are at a distance to one another with regard to a vertical y axis, in particular arranged above one another with regard to the vertical y axis, or that the first pivot carrier axis and the second pivot carrier axis that runs parallel to the first pivot carrier axis run parallel to a vertical y axis, whereby the first pivot carrier axis and the second pivot carrier axis are at a distance to one another with regard to a horizontal x axis, in particular that they are arranged next to one another with regard to the horizontal x axis.

6. The machine tool according to claim 1, wherein the at least one first work spindle is mounted to rotate around a first spindle axis and/or that the at least one second work spindle is mounted around a second spindle axis, in particular whereby the first spindle axis and/or the second spindle axis runs/run parallel to a horizontal z axis that runs transverse to the vertical y axis and transverse to the horizontal x axis and/or in particular whereby the first spindle axis and the second spindle axis run parallel to one another.

7. The machine tool according to claim 1, wherein the first work spindle and the second work spindle can be decoupled with respect to their kinematics and can be operated and/or moved separately and independently of one another and/or in which the first work spindle and the second work spindle are coupled with respect to their kinematics and can be operated and/or moved together and simultaneously.

8. The machine tool according to claim 1, wherein the first work spindle and the second work spindle are arranged vertically above one another, if the first pivot carrier axis and the second pivot carrier axis that runs parallel to the first pivot carrier axis run parallel to a horizontal x axis, and if the first work spindle and the second work spindle are arranged horizontally next to one another, if the first pivot carrier axis and the second pivot carrier axis that runs parallel to the first pivot carrier axis run parallel to a vertical y axis.

9. The machine tool according to claim 1, wherein the respective first workpiece table is swivel mounted around a first workpiece table axis, which runs parallel or transversely to the allocated first pivot carrier axis of the first pivot carrier or second pivot carrier axis of the second pivot carrier and/or if the respective second workpiece table runs around a second workpiece table axis that runs parallel or transversely to the allocated first pivot carrier axis of the first pivot carrier or rather the second pivot carrier axis of the second pivot carrier.

10. The machine tool according to claim 9, wherein the first pivot carrier axis, the second pivot carrier axis and the first workpiece table axes and the second workpiece table axes run parallel to one another and parallel to the horizontal x axis, whereby the first pivot carrier axis and the second pivot carrier axis, whereby the first workpiece table axes with one another and/or wherein the second workpiece table axes are aligned with one another with respect to the vertical y axis extending transversely to them or are offset with respect to one another or that the first pivot carrier axis, the second pivot carrier axis as well as the first workpiece table axes and the second workpiece table axes run parallel to one another and parallel to the vertically extending y axis, wherein the first pivot carrier axis and the second pivot carrier axis, wherein the first workpiece table axes are aligned with one another and/or wherein the second workpiece table axes are arranged offset from one another with respect to the horizontal X-axis extending transversely to them.

11. The machine tool according to claim 9, wherein the first pivot position and in the second pivot position, the first workpiece table and the second workpiece table of a pivot carrier are each arranged point-symmetrically to one another with respect to the associated pivot carrier axis of the respective pivot carrier on which they are arranged and, if the respective pivot carrier axis runs horizontally, the first workpiece table and the second workpiece table are arranged offset to one another with respect to a vertical axis and, in particular, the pivoting ranges of the first workpiece table and the second workpiece table of the associated pivot carrier overlap with a vertical plane running through the pivot carrier axis, and if the respective pivot carrier axis runs vertically, the first workpiece table and the second workpiece table are arranged offset relative to one another with respect to a horizontal axis and, in particular, the pivoting ranges of the first workpiece table and the second workpiece table of the associated pivot carrier overlap with a horizontal plane running through the pivot carrier axis.

12. The machine tool according to claim 9, wherein on the first pivot carrier the distance between the first pivot carrier axis and the first workpiece table axis is less than the circumferential radius of the first workpiece table and/or the distance between the first pivot carrier axis and the second workpiece table axis is less than the circumferential radius of the second workpiece table, and/or if on the second pivot carrier the distance between the second pivot carrier axis and the first workpiece table axis is less than the circumferential radius of the first workpiece table and/or the distance between the second pivot carrier axis and the second workpiece table axis is less than the circumferential radius of the second workpiece table.

13. The machine tool according to claim 1, wherein the first pivot carrier comprises a first partition wall by which the first workpiece table and the second workpiece table are spatially separated from each other in the first pivot position and in the second pivot position and the loading area is shielded from the working area in full or at least in sections and/or if the second pivot carrier includes a second partition wall by means of which the first workpiece table and the second workpiece table are spatially separated from one another in the first pivot position and in the second pivot position and the loading area is shielded from the working area in full or at least in sections.

14. The machine tool according to claim 13, wherein the first partition wall of the first pivot carrier can be flexibly and/or elastically bent around an axis running parallel to the first pivot carrier axis and/or that the second partition wall of the second pivot carrier can be flexibly and/or elastically bent around an axis running parallel to the second pivot carrier axis.

15. The machine tool according to claim 13, wherein the machine frame includes at least one separating section, which is arranged between the first pivot carrier and the second pivot carrier, wherein the first partition wall of the first pivot carrier, the separating section of the machine frame and the second partition wall of the second pivot carrier spatially separate the working area from the loading area in the first pivot position and in the second pivot position in full or at least in sections without gaps and/or joints.
